(19) United States
(12) Patent Application Publication
(10) Pub. No.: US 2015/0113125 A1
(43) Pub. Date: Apr. 23, 2015

(54) System and Method for Providing the Status of Safety Critical Systems to Untrusted Devices

(71) Applicant: Cisco Technology Inc., San Jose, CA (US)

(72) Inventors: Brian Chamberlin, Yorba Linda, CA (US); Simon Parnall, Kingswood (GB); Hillel Solow, Beit Shemesh (IL); Yaron Sella, Beit Nekofa (IL); Aviad Kipnis, Efrat (IL); Perry Smith, Maale Adumim (IL)

(21) Appl. No.: 14/061,165

(22) Filed: Oct. 23, 2013

(51) Int. Cl. H04L 12/26; H04L 29/08

(52) U.S. Cl. CPC H04L 43/0805; H04L 67/10
USPC 709/224

(57) ABSTRACT

A system and method is described for providing the status of safety critical systems to untrusted devices.

### BACKGROUND OF THE INVENTION

WO2012130257 describes an arrangement for storing a data set in an ECU (electronic control unit) in a vehicle control system, wherein the arrangement comprises a computer means connected to the vehicle, where the computer means is adapted to execute an access application, where the access application comprises vehicle specific information and service action specific information, and where the information is encrypted, where the arrangement is adapted to decrypt the vehicle specific information and the service action specific information, to unlock the vehicle ECU by sending a password from the computer means to the ECU, to perform a service action by storing service action specific information in the ECU, to lock the ECU by sending a lock command to the ECU from the computer means, and to corrupt the access application software such that it cannot be used again.

WO2012114271 describes methods, circuits, apparatus, systems and associated software applications for providing security on one or more servers, including virtual servers. A server operating system may include or be otherwise functionally associated with a firewall application, which firewall application may regulate IP port access to resources on the server. A port-tending agent or application (PorTender) running on the server, or on a functionally associated computing platform, may monitor and regulate server port status (e.g. opened, closed, and conditionally opened). The PorTender may initiate and engage in communication sessions with a policy server, from which policy server the PorTender may receive port, user and security policies and/or settings.

EP2346723A2 describes a vehicle security system which includes a controller having at least one of a vehicle security module and a playback module. The vehicle security module may operate in a secure once mode of operation or in a secure all mode of operation. The playback module records ride information associated with the vehicle. The ride information may be provided to an external device.

US20090217058 describes systems and/or methods that can facilitate controlling access to secure memory blocks within a memory module. The subject innovation can employ key components that can contain two or more storage locations for authentication information that can facilitate controlling access to secure memory block components. Secure memory block counter components can be employed to indicate which storage location within the key component contains current authentication information associated with the respective secure memory block components. The disclosed subject matter allows for multiple secure memory block components to have separate authentication information to provide more than one user or entity to store data in their own secure memory block component. Multiple storage locations associated with the key components to substantially alleviated or eliminate the loss of secure areas of a memory module if power is lost during the updating of the authentication information associated with the secure areas.

U.S. Pat. No. 7,366,892 describes a telematics system that includes a security controller is provided. The security controller is responsible for ensuring secure access to and controlled use of resources in the vehicle. The security measures relied on by the security controller can be based on digital certificates that grant rights to certificate holders, e.g., application developers. In the case in which applications are to be used with vehicle resources, procedures are implemented to make sure that certified applications do not jeopardize vehicle resource security and vehicle users' safety. Relationships among interested entities are established to promote and support secure vehicle resource access and usage. The entities can include vehicle makers, communication service providers, communication apparatus vendors, vehicle subsystem suppliers, application developers, as well as vehicle owners/users. At least some of the entities can be members of a federation established to enhance and facilitate secure access and usage of vehicle resources.

### SUMMARY OF THE INVENTION

There is thus provided in accordance with an embodiment of the present invention a system including a first network, the first network including a first communications bus over which a plurality of trusted devices and systems are adapted to communicate, the plurality of devices and systems including at least one safety critical system, a second network, the second network including a second communications bus over which at least one untrusted device is adapted to communicate, a monitor device which is connected to and can communicate on both the first communications bus and the second communications bus, the monitor device having a data structure that represents various states of one or more the plurality of trusted devices or systems on the first network, the monitor device updating the data structure when an update about the state of one of the plurality of trusted devices or systems is received via the first network, a processor which, when the monitor device receives, from the at least one untrusted device, a request for the state of one of the trusted devices or systems, replies to the at least one untrusted device with the state of the one of the trusted devices or systems from the internal data structure that represents the states of each trusted device on the first network.

Further in accordance with an embodiment of the present invention the monitor device passively monitors the first network.

Still further in accordance with an embodiment of the present invention the monitor device receives an update about the state of one of the plurality of trusted devices at a predetermined time interval.

Additionally in accordance with an embodiment of the present invention the at least one untrusted device communicates with the monitor device via an applications programming interface.

Moreover in accordance with an embodiment of the present invention the first communications bus includes one of the following communications buses Flexray, CAN, Ethernet, LIN, and MOST.

Further in accordance with an embodiment of the present invention the second communications bus includes one of the following communications buses Flexray, CAN, Ethernet, LIN, and MOST.

Still further in accordance with an embodiment of the present invention the monitor device receives a message from a first device of the plurality of trusted devices sent to a second device of the plurality of trusted devices and updates the data structure on the basis of the received message.

Additionally in accordance with an embodiment of the present invention at least one device of the plurality of trusted devices sends status information to the monitor device at a predetermined interval.

Moreover in accordance with an embodiment of the present invention the monitor device is unable to pass a message received over the second communications bus to the first communications bus.

Further in accordance with an embodiment of the present invention the monitor device is unable to send messages over the first communications bus.

There is also provided in accordance with another embodiment of the present invention monitor device including a connection to a first network external to the monitor device, the first network including a first communications bus adapted to communicate with a plurality of trusted devices and systems are connected, the plurality of devices including at least one safety critical system, a first communication port adapted to receive messages sent to the trusted network, and is thereby able to receive messages sent from one trusted device on the first network to a second trusted device on the first network, a data structure that represent the state of at least one or more of the plurality of trusted devices and systems on the first network, a processor which updates the data structure each time an update about the state of one of the plurality of trusted devices and systems is received over the first network, wherein the message may either have been directly sent to the monitor device or the message may have been sent to one of the plurality of the trusted devices and systems on the first network to a second trusted device on the first network, and a connection to a second network external to the monitor device, the second network including a second communications bus adapted to communicate with at least one untrusted device, wherein when the monitor device receives a request for the state of one of the plurality of trusted devices and systems on the trusted network from the at least one untrusted device, the monitor device replies to the at least one untrusted device with a state of the one of the plurality of trusted devices and systems from the internal data structure that represents the states of each trusted device and system on the first network.

Further in accordance with an embodiment of the present invention the monitor device is unable to pass a message received over the second communications bus to the first communications bus.

Still further in accordance with an embodiment of the present invention the monitor device is unable to send messages over the first communications bus.

There is also provided in accordance with still another embodiment of the present invention a method including receiving, over a first network, a state update from at least one of a plurality of trusted devices and systems, the first network including a first communications bus over which the plurality of trusted devices and systems are adapted to communicate, the plurality of devices and systems including at least one safety critical system, transmitting the state update to a monitor device, the monitor device having a data structure that represents various states of one or more of the plurality of trusted devices or systems on the first network, the monitor device updating the data structure when an update about the state of one of the plurality of trusted devices or systems is received via the first network, receiving, at the monitor device, over a second network, a request from at least one untrusted device for the state of one of the trusted devices or systems, the second network including a second communications bus over which the at least one untrusted device is adapted to communicate, replying to the request from the at least one untrusted device with the state of the one of the trusted devices or systems from the internal data structure that represents the states of each trusted device on the first network.

### BRIEF DESCRIPTION OF THE DRAWINGS

The present invention will be understood and appreciated more fully from the following detailed description, taken in conjunction with the drawings in which:

FIG. 1 is a simplified block diagram illustration of a system for providing status information about safety critical systems to untrusted devices, the system constructed and operative in accordance with an embodiment of the present invention;

FIG. 2A is a data flow diagram of an implementation of the system of FIG. 1;

FIG. 2B is a data flow diagram of an alternative implementation of the system of FIG. 1;

FIG. 3 is a block diagram illustration of a monitor device of the system of FIG. 1;

FIG. 4 is a partially block diagram, partially pictorial depiction of one embodiment of the system of FIG. 1; and

FIG. 5 is a flowchart diagram of a method of implementing the system of FIG. 1.

### DETAILED DESCRIPTION OF AN EMBODIMENT

A safety critical system is any system where errors or faults can have serious consequences. For example, and without limiting the generality of the foregoing, in an automobile, the Electronic Control Modules (ECMs, also referred to as Electronic Control Units, ECUs) that control the throttle and brake are connected together via a communication bus. The brake, the throttle, and the engine controllers are all considered safety critical systems because errors in the communications between the brake, throttle, and engine controllers could result in an automobile accident.

Typically a safety critical system is designed to only allow access to trusted applications. With the introduction of advanced entertainment systems into motor vehicles, particularly entertainment systems with an external network connection, this situation is changing. The advanced entertainment systems in motor vehicles typically may also attempt to access information about the vehicle (for instance, the current speed) but allowing this access could expose vehicle based safety critical systems to serious problems that could result in a vehicle accident.

In-vehicle entertainment systems are now being delivered with network connections and are often able to download third party applications. This exposes the entertainment system to viruses, rogue software, and being compromised by outside parties. This potential exposure to malware and increased risk of being compromised makes the in-vehicle entertainment system an untrusted device.

Devices and systems which are safety critical must, by contrast, be trusted devices, i.e. must not have a potential for infection by malware, introduced by exposure to an external network or device. For example, and without limiting the generality of the foregoing, a virus may be downloaded to an in-vehicle MP3 player either by downloading a song which bears the virus from the Internet, or from inserting a virus infected disk-on-key into the USB port of the in-vehicle MP3 player. However, under no circumstances should that virus be allowed to infect the vehicle braking system, for example. Such an infection may result in loss of life or limb, or may cause property damage.

In a typical one-way network, a device on a secure network can be configured to send any arbitrary message to devices on a non-secure network. However, the device on the secure network must be configured in advance with appropriate protocols to communicate with devices on the non-secure network. For example, a vehicle's control system could be configured to send messages to the vehicle's entertainment system. However, there would be no way for the vehicle's control system to send messages to the driver's mobile phone, because the vehicle's control system typically does not possess the information that this mobile phone exists. One way to fix this problem is by adding a gateway point which could be configured to forward messages received from the secure network to arbitrary clients on the non-secure network, but this is not an ideal approach, as the information being sent is the real time state information of the devices on the secure network, thereby providing potentially more information to the arbitrary clients on the non-secure network than would be secure to provide. Either all messages received would be broadcast to the non-secure device or non-secure device would be given a way to register in order to receive only the messages it is requires. In either of these cases, the non-secure device is then responsible for processing these messages in real-time, the non-secure device must have detailed technical knowledge of the types of messages it will receive. Additionally, providing such messages to the non-secure device adds extra unnecessary traffic to the secure network.

Accordingly, the above-mentioned limitations may be overcome by introducing a data structure (which may be comprised in an appropriate device) to cache state information about the secure network. Communication from the secure network to the device comprising the data structure is over the secure network. On a different (non-secure) network, an API that supports any arbitrary device allows communication with the data structure. In this fashion, only the device comprising the data structure needs to communicate with the systems on the secure network and capture data from those systems in real time. All other devices, being on the non-secure network, can request the information from the data structure only when they need that information. It is appreciated that the API is designed to only provide information which is needed for the devices on the non-secure network. Any information which, in implementation is not needed by devices on the non-secure network will not be included in the API.

The device comprising the data structure, for instance, a monitor device, passively monitors the state of devices on the secure network. Devices on the secure network may also send state updates to the monitor device at predetermined fixed intervals. Alternatively, state updates may be sent at episodically determined intervals, or after a state change, or at other times, as appropriate. Different devices on the secure network may have different, scattered predetermined fixed intervals at which they will send state updates, in order to reduce the amount of traffic on the secure network at any given time. It is appreciated that the term “passively monitors” as used herein, in all of its various grammatical forms, is understood to mean that the monitor that is performing the passive monitoring receives a copy of all messages sent on a network regardless of which device the message was addressed to.

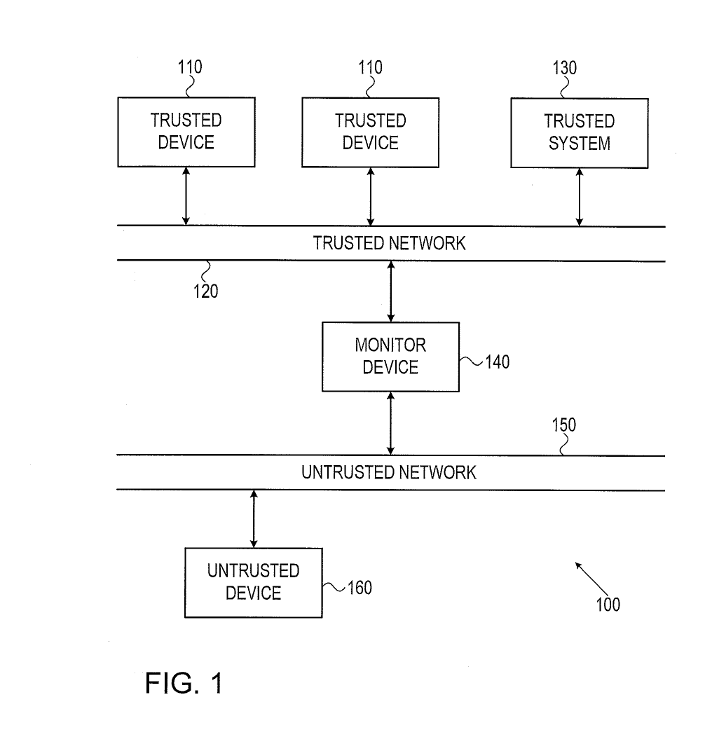

Reference is now made to FIG. 1, which is a simplified block diagram illustration of a system 100 for providing status information about safety critical systems to untrusted devices, the system constructed and operative in accordance with an embodiment of the present invention.

A number of trusted devices 110 are joined to a first communications bus 120 comprising a trusted network. A trusted system 130, comprising a plurality of devices (for instance a braking system in an automobile may comprise a brake pedal, an ECU which controls the braking system, as well as an actual braking mechanism which slows down the vehicle's wheels) is also joined to the first communications bus 120. The trusted devices 110 and the trusted system 130 is controlled by a controller (not depicted), which provides computer processing power for the operation of the trusted devices 110 and the trusted system 130. In vehicular systems, such controllers are typically ECUs.

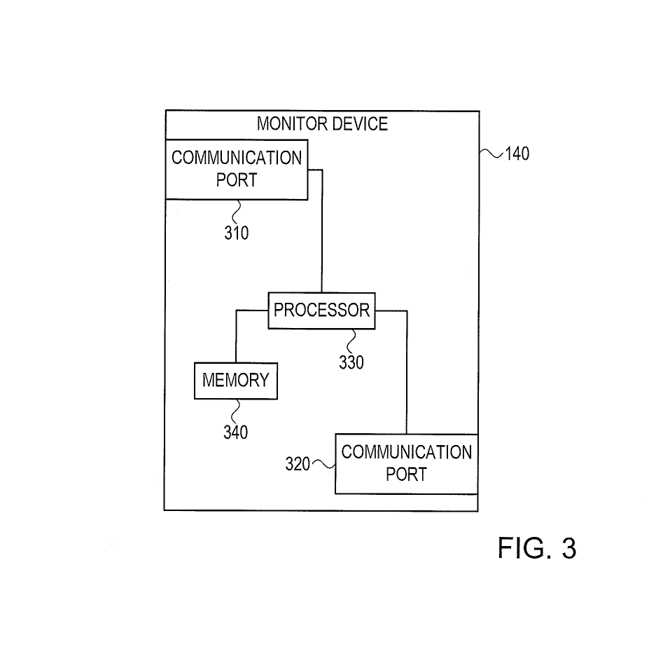

The first communications bus 120 is also in communication with a monitor device 140. The monitor device 140 will be described in greater detail below, with reference to FIG. 3.

In addition to being in communication with the first communications bus 120, the monitor device 140 is also in communication with a second communications bus 150, comprising an untrusted communication network. At least one untrusted device 160 is also in communication with the monitor device 140 via the second communications bus 150. As the monitor device 140 is situated on both the first communications bus 120 and the second communications bus 150, the monitor 140 comprises a “window” to the first communications bus 120 from which untrusted devices 160, situated only on the second communications bus 150, can observe the state of the trusted devices 110 and the trusted system 130, but cannot affect the trusted devices 110 and the trusted system 130 in any way. That is to say, information may move from the first communications bus 120 to the second communications bus 150, but not from the second communications bus 150 to the first communications bus 120.

Either one or both of the first communications bus 120 and the second communications bus 150 may, for example, and without limiting the generality of the foregoing, be any of the following well known communication buses:
Flexray;
CAN;
Ethernet;
LIN; and
MOST.

It is also appreciated that the first communications bus 120 and the second communications bus 150 may also include, either in their entirety or in part, wireless communication protocols.

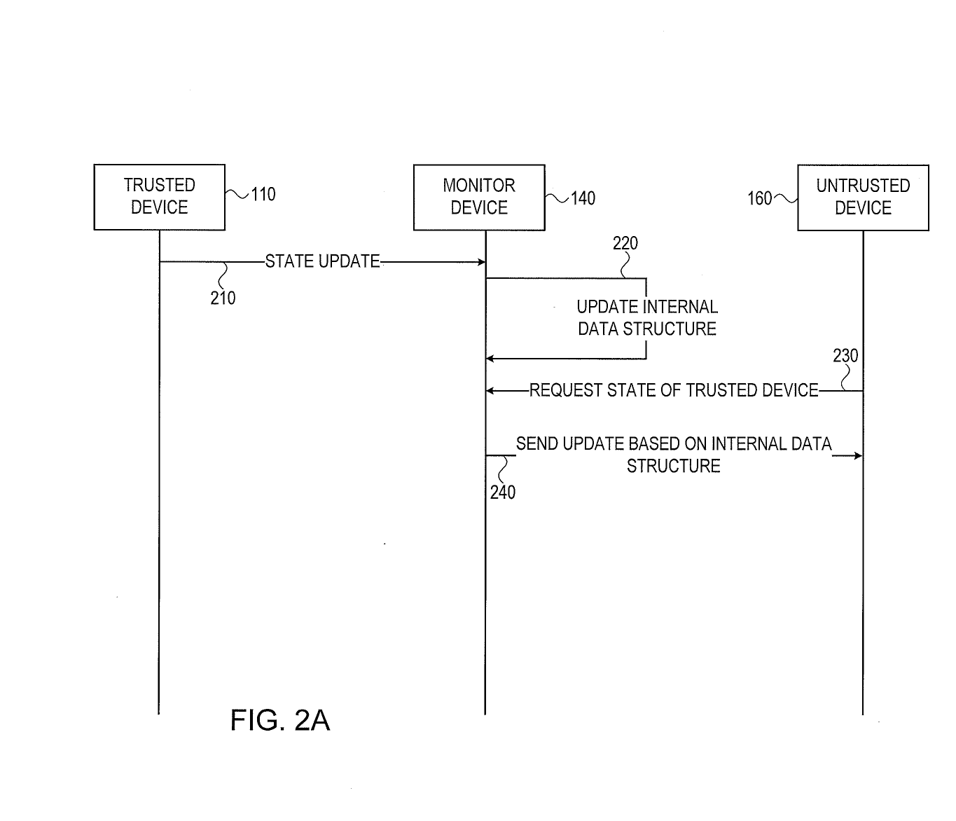

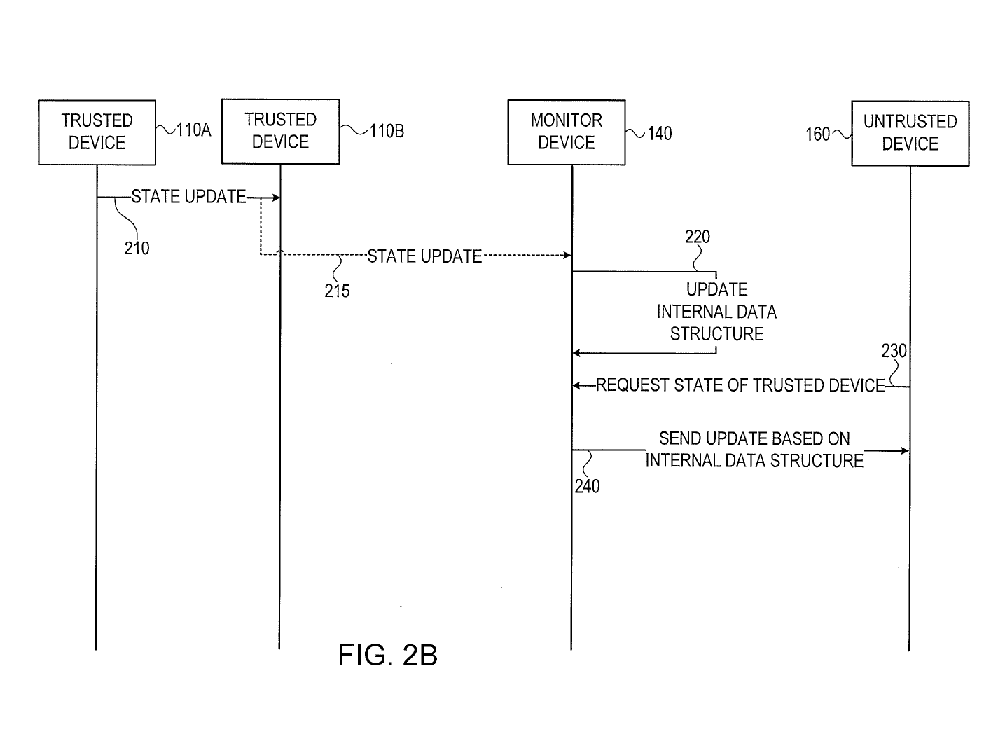

The operation of the system 100 of FIG. 1 is described with additional reference made to FIG. 2A. FIG. 2A is a data flow diagram of an implementation of the system 100 of FIG. 1. The monitor device 140 is designed to have an internal data structure comprising, at least in potential, state information about each trusted device 110 and trusted system 130 on the first communications bus 120 (i.e. the trusted network). Furthermore, the monitor device 140 comprises a communication mechanism which includes all of the protocols needed to monitor all of the trusted devices 110 and systems 130 on the first communications bus 120. (Note that the trusted system 130 is not depicted in FIG. 2A. However, the trusted system 130 may be substituted for the trusted devices 110 in FIG. 2A (that is to say that although the figure depicts the trusted device 110, it could have been depicted with the trusted system 130. Although the explanation of the figure relates to the trusted device 110, it is understood that, in fact, either the trusted device 110 or the trusted system 130 could have been shown in the figure).

As noted above, the internal data structure comprised in the monitor device 140 stores the states of the trusted devices 110 and trusted system 130 which communicates over the first communications bus 120. Accordingly, when any of the trusted devices 110 or trusted system 130 sends an update of its state (step 210) over the first communications bus 120, the monitor device 140 receives the state update. Even had the monitor device 140 not requested the update, and even if the update is addressed to a different trusted device 110 or trusted system 130, the monitor device 140 receives the state update. The monitor device 140 then correspondingly updates its internal data structure (step 220) to reflect the state update received in step 210.

Reference is now made to FIG. 2B, which is a data flow diagram of an alternative implementation of the system of FIG. 1. In the implementation depicted in FIG. 2B, the monitor device passively monitors communications which occur on the first communications bus 120 (i.e. the trusted network)—i.e. it sniffs the trusted network. When the state update sent in step 210 is sent from a first trusted device 110A to a second trusted device 110B, the state update is also detected by the monitor device 140 (step 215). The monitor device 140 then correspondingly updates its internal data structure (step 220) to reflect the state update received in step 210. The discussion now returns to the discussion of FIG. 2A, which, from step 220 onwards, is the same as FIG. 2B.

At a later time, when a request is made by the at least one untrusted device 160 over the second communications bus 150 for the state of one of the trusted devices 110 (step 230), the monitor device 140 sends a response (step 240) to the request with the last update of the state of the requested trusted device 110 based on the stored state of the trusted device 110, as that state is stored in the internal data structure at that time.

It is appreciated that in cases where trusted devices 110 or trusted system 130 do not send enough data via the first communications bus 120 for the monitor device 140 to determine the state of the sending trusted devices 110 or trusted system 130 (i.e. when the monitor device 140 is not able to determine the values of some or all of the fields in the data structure), the monitor device 140 may be operative to poll trusted devices 110 or the trusted system 130 for status data on a regular basis or on a pre-scheduled basis. However, in order to prevent a possible denial of service attack on the part of the untrusted device 160, the monitor device 140 may not poll devices on the first communications bus 120 in response to a request from the untrusted device 160.

Reference is now made to FIG. 3, which is a block diagram illustration of the monitor device 140 of the system 100 of FIG. 1. The monitor device 140 comprises a first communications port 310, which is adapted to be in communication with the first communications bus 120 (FIG. 1). The monitor device 140 further comprises a second communications port 320, which is adapted to be in communication with the second communications bus 150 (FIG. 1). Data received over the first communications port 310 and the second communications port 320 are input to a processor 330. The processor 330 updates the internal data structure when an update about the state of one of the trusted devices 110 and systems 130 is received by the monitor device. The processor is designed and implemented such that when the monitor device 140 receives, from at least one of the untrusted devices 160 (FIG. 1) via the second communications port 320, a request for the state of one of the trusted devices, the processor ensures that the monitor device 140 replies to the request for the state of one of the trusted devices 110 or trusted systems 130 with the state of the one of the trusted devices 110 or trusted systems 130 from the internal data structure that represents the states of each trusted device on the first network. This ensures that the at least one untrusted device 160 is able to receive the state of the at least one of the trusted devices 110 or trusted systems 130, but is unable to affect any of the trusted devices 110 or trusted systems 130.

The monitor device 140 also comprises a memory 340 or other appropriate storage device which is accessible by the processor 330. The memory 340 stores the internal data structure for updates and retrieval of information stored therein by the processor.

It is appreciated that, although depicted as having a single first communications port 310 and a single second communications port 320, the monitor device 140 may in fact have a plurality of first communications ports 310 and second communications ports 320, each one of which is adapted for one of the different types of communications buses mentioned above, or other appropriate methods of communication.

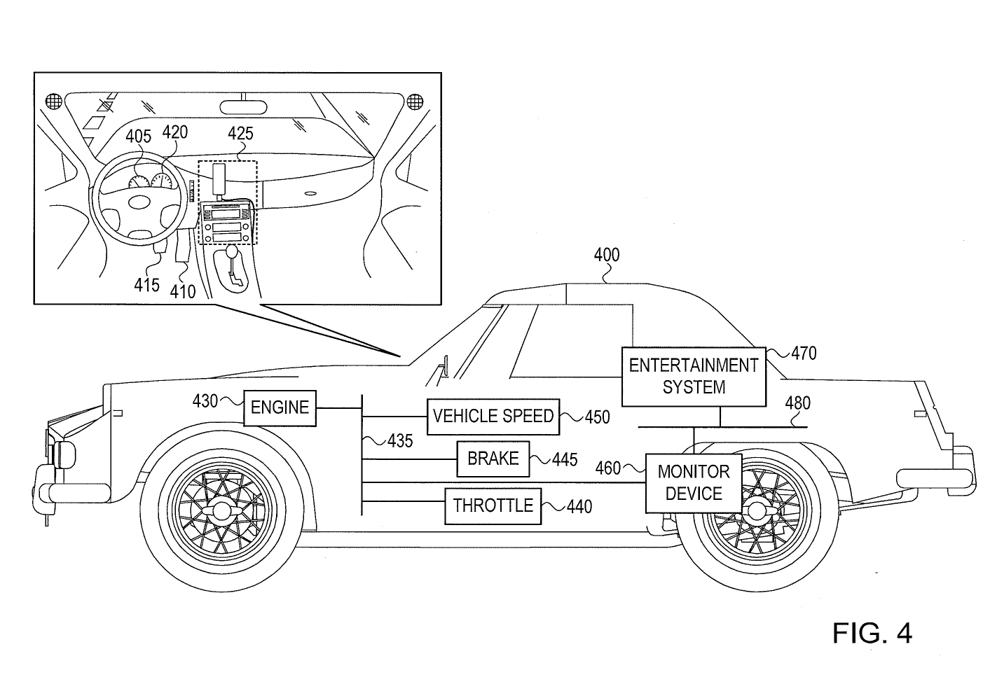

Reference is now made to FIG. 4, which is a partially block diagram, partially pictorial illustration of one embodiment of the system 100 of FIG. 1. The illustration of FIG. 4 depicts how the system 100 of FIG. 1 may be embodied in a vehicular system. Other systems (e.g. avionic systems, nautical systems, and medical systems) which also have either or both trusted and untrusted devices may also comprise other embodiments of the system 100 of FIG. 1. The depiction of FIG. 4 is not meant to be limiting, and is merely brought as one exemplary embodiment of the system 100 of FIG. 1.

As is typical of vehicular systems, the vehicle 400 comprises an engine, having an engine speed (indicated by a tachometer 405), a throttle 410 (i.e. an accelerator pedal), and a brake pedal 415. The vehicle 400 itself has a vehicle speed (indicated by a speedometer 420). The vehicle 400 also has a vehicle entertainment system 425.

The vehicle's 400 engine is in communication with an engine ECU 430. The engine ECU 430 monitors the engine speed (and may communicate the vehicle 400 speed to the speedometer 420). The engine ECU 430 is adapted to communicate over a trusted network 435, that is to say, the first communications bus 120 (FIG. 1). Typically, in automotive vehicular systems, the first communications bus 120 comprises a CAN bus, as is known in the art. Likewise, an ECU which serves as a throttle controller 440; an ECU which serves as a brake controller 445; and an ECU which serves as a vehicle speed controller 450 also communicate via the trusted network 435 over the CAN bus.

A monitor device 460 is in communication with the various trusted devices on the trusted network 435, namely: the engine ECU 430; the throttle controller ECU 440; the brake controller ECU 445; and the vehicle speed controller ECU 450. Accordingly, the monitor device 460 operates according to communication protocols relevant to the CAN bus, and “understands” messages on the CAN bus.

The monitor device 460 is also in communication with untrusted devices, such as the ECU 470 which controls the vehicle entertainment system 425 over an untrusted communication network 480, that is to say, the second communications bus 150 (FIG. 1).

By way of example, when the vehicle 400 is in motion, the throttle controller 440 and the engine controller 430 will send messages to each other via the CAN bus (i.e. the trusted network 435). In this case, the monitor device 460 will also receive this message and will update its throttle position state stored in the internal data structure accordingly.

The vehicle entertainment system 425 is susceptible to being “infected” with malware, such as, and without limiting the generality of the foregoing, a virus, or rogue software through an external network or direct connection with an infected device. Should the vehicle entertainment system 425 be compromised by outside parties, the monitor device 460 serves as a mechanism to prevent the infection from spreading from the untrusted communication network 480 to the trusted network 435. Even if the vehicle entertainment system 425 becomes infected with malware and attempts to spoof the vehicle speed controller 450, indicating to the brake controller 445, the throttle controller 440 and the engine controller 430 that the vehicle 400 is moving faster or slower than the vehicle 400 is actually moving, packets which contain the spoofed message would reach the monitoring device 460, which, as explained above, would not transfer the packets containing the spoofed message from the untrusted network 480 to the trusted network 435.

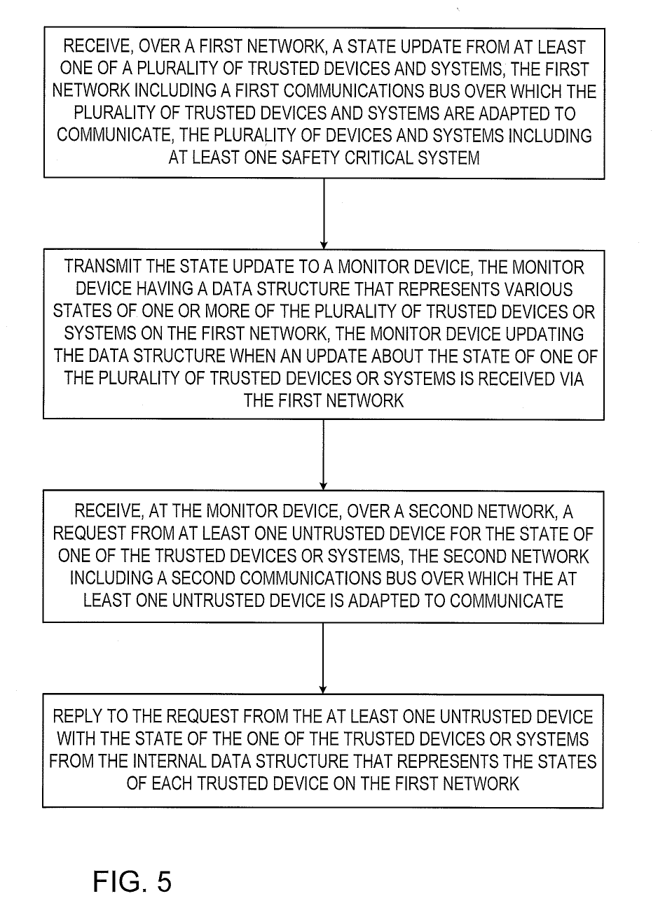

Reference is now made to FIG. 5, which is a flowchart diagram of a method of implementing the system of FIG. 1. FIG. 5 is believed to be self-explanatory in light of the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system comprising:
a first network, the first network comprising a first communications bus over which a plurality of trusted devices and systems are adapted to communicate, the plurality of devices and systems comprising at least one safety critical system;
a second network, the second network comprising a second communications bus over which at least one untrusted device is adapted to communicate;
a monitor device which is connected to and can communicate on both the first communications bus and the second communications bus, the monitor device having a data structure that represents various states of one or more the plurality of trusted devices or systems on the first network, the monitor device updating the data structure when an update about the state of one of the plurality of trusted devices or systems is received via the first network;
a processor which, when the monitor device receives, from the at least one untrusted device, a request for the state of one of the trusted devices or systems, replies to the at least one untrusted device with the state of the one of the trusted devices or systems from the internal data structure that represents the states of each trusted device on the first network.

2. The system according to claim 1 wherein the monitor device passively monitors the first network.

3. The system according to claim 1 wherein the monitor device receives an update about the state of one of the plurality of trusted devices at a predetermined time interval.

4. The system according to claim 1 wherein the at least one untrusted device communicates with the monitor device via an applications programming interface.

5. The system according to claim 1 wherein the first communications bus comprises one of the following communications buses: Flexray; CAN; Ethernet; LIN; and MOST.

6. The system according to claim 1 wherein the second communications bus comprises one of the following communications buses: Flexray; CAN; Ethernet; LIN; and MOST.

7. The system according to claim 1 wherein the monitor device receives a message from a first device of the plurality of trusted devices sent to a second device of the plurality of trusted devices and updates the data structure on the basis of the received message.

8. The system according to claim 1 wherein at least one device of the plurality of trusted devices sends status information to the monitor device at a predetermined interval.

9. The system according to claim 1 wherein the monitor device is unable to pass a message received over the second communications bus to the first communications bus.

10. The system according to claim 1 wherein the monitor device is unable to send messages over the first communications bus.

11. A monitor device comprising:
a connection to a first network external to the monitor device, the first network comprising a first communications bus adapted to communicate with a plurality of trusted devices and systems are connected, the plurality of devices comprising at least one safety critical system;
a first communication port adapted to receive messages sent to the trusted network, and is thereby able to receive messages sent from one trusted device on the first network to a second trusted device on the first network;
a data structure that represent the state of at least one or more of the plurality of trusted devices and systems on the first network;
a processor which updates the data structure each time an update about the state of one of the plurality of trusted devices and systems is received over the first network, wherein the message may either have been directly sent to the monitor device or the message may have been sent to one of the plurality of the trusted devices and systems on the first network to a second trusted device on the first network; and
a connection to a second network external to the monitor device, the second network comprising a second communications bus adapted to communicate with at least one untrusted device,
wherein when the monitor device receives a request for the state of one of the plurality of trusted devices and systems on the trusted network from the at least one untrusted device, the monitor device replies to the at least one untrusted device with a state of the one of the plurality of trusted devices and systems from the internal data structure that represents the states of each trusted device and system on the first network.

12. The device according to claim 11 wherein the monitor device is unable to pass a message received over the second communications bus to the first communications bus.

13. The device according to claim 11 wherein the monitor device is unable to send messages over the first communications bus.

14. A method comprising:
receiving, over a first network, a state update from at least one of a plurality of trusted devices and systems, the first network comprising a first communications bus over which the plurality of trusted devices and systems are adapted to communicate, the plurality of devices and systems comprising at least one safety critical system;
transmitting the state update to a monitor device, the monitor device having a data structure that represents various states of one or more of the plurality of trusted devices or systems on the first network, the monitor device updating the data structure when an update about the state of one of the plurality of trusted devices or systems is received via the first network;
receiving, at the monitor device, over a second network, a request from at least one untrusted device for the state of one of the trusted devices or systems, the second network comprising a second communications bus over which the at least one untrusted device is adapted to communicate;
replying to the request from the at least one untrusted device with the state of the one of the trusted devices or systems from the internal data structure that represents the states of each trusted device on the first network.
